(19) United States
(12) Patent Application Publication
(10) Pub. No.: US 2019/0351526 A1
(43) Pub. Date: Nov. 21, 2019

(54) METHOD OF DETECTING A POLISHING SURFACE OF A POLISHING PAD USING A POLISHING HEAD, AND POLISHING APPARATUS

(71) Applicant: Ebara Corporation, Tokyo (JP)

(72) Inventors: Masao UMEMOTO, Tokyo (JP); Ryuichi KOSUGE, Tokyo (JP); Shuichi KAMATA, Tokyo (JP); Kento YOSHIDA, Tokyo (JP)

(73) Assignee: Ebara Corporation, Tokyo (JP)

(21) Appl. No.: 16/408,960

(22) Filed: May 10, 2019

(30) Foreign Application Priority Data
May 18, 2018 (JP) 2018-096000

(51) Int. Cl. B24B 49/16; B24B 37/27; B24B 37/005

(52) U.S. Cl. CPC B24B 49/16; G01B 21/32; B24B 37/005; B24B 37/27

(57) ABSTRACT

A method capable of accurately detecting a polishing surface of a polishing pad using a polishing head without being influenced by passage of time is disclosed. The includes: moving a polishing head in a direction perpendicular to a polishing surface of a polishing pad while applying thrust from the polishing head to the polishing pad; during the movement of the polishing head, detecting deflection of a head arm with a strain sensor, the head arm supporting the polishing head; and determining a position of the polishing head corresponding to a point in time at which an output signal from the strain sensor reaches a preset threshold value.

### CROSS REFERENCE TO RELATED APPLICATION

This document claims priority to Japanese Patent Application Number 2018-096000 filed May 18, 2018, the entire contents of which are hereby incorporated by reference.

### BACKGROUND

In a manufacturing process of a semiconductor device, it increasingly becomes important to planarize a surface of the semiconductor device. One of the most important planarizing technologies is chemical mechanical polishing (CMP). The chemical mechanical polishing is performed using a polishing apparatus. Specifically, a polishing head presses a substrate, such as a wafer, against a polishing surface of a polishing pad to polish the substrate, while a polishing liquid containing abrasive particles, such as silica (SiO₂) or the like, is supplied onto the polishing surface.

As dressing (or conditioning) of the polishing surface of the polishing pad and polishing of a substrate are repeatedly performed, the polishing pad gradually wears. A distance between the polishing head and the polishing surface of the polishing pad greatly affects a polishing profile of a substrate. Therefore, it is important to keep a constant distance between the polishing head and the polishing surface of the polishing pad.

In order to keep the constant distance between the polishing head and the polishing surface, it is necessary to detect the polishing surface of the polishing pad. Therefore, a so-called pad search for detecting the polishing surface of the polishing pad is performed. Specifically, the pad search is performed using the polishing head as follows. The polishing head, holding a dummy wafer, is lowered by an actuator composed of a servomotor and a ball-screw mechanism. When the dummy wafer contacts the polishing surface of the polishing pad, a thrust of the polishing head is applied to the polishing surface through the dummy wafer. The lowering of the polishing head is stopped when a preset thrust is reached.

A position of the polishing head can be determined from the number of rotations of the servomotor and a thread pitch of the ball-screw mechanism. The thrust can be determined indirectly from a motor current supplied to the servomotor. Therefore, when the motor current reaches a threshold value corresponding to the preset thrust, the servomotor is stopped. The position of the polishing head when the servomotor is stopped is the position of the polishing head when the entire bottom surface of the dummy wafer is in contact with the polishing surface. In other words, the servomotor is stopped when the entire bottom surface of the dummy wafer is brought into contact with the polishing surface. In this way, the pad search is performed while monitoring the motor current (i.e. torque of the servomotor).

However, there are several sliding elements, such as the above-mentioned ball-screw mechanism and a ball spline bearing between the polishing head and the servomotor. When these sliding elements are in motion, frictional forces are inevitably generated. Since these frictional forces change with time, the actual thrust applied from the polishing head to the polishing pad when the motor current reaches the above-mentioned threshold value also changes with time. In other words, the position of the polishing head when the motor current reaches the threshold value changes with the passage of time. As a result, a relative position between the polishing head and the polishing surface changes, and a desired polishing profile of the substrate cannot be obtained. Furthermore, frequent calibrations are required to obtain an accurate relationship between the thrust and the motor current.

### SUMMARY OF THE INVENTION

According to embodiments, there are provided a method and a polishing apparatus capable of accurately detecting a polishing surface of a polishing pad using a polishing head without being influenced by passage of time.

Embodiments, which will be described below, relate to a technique of polishing a substrate, such as a wafer, and more particularly to a method of detecting a polishing surface of a polishing pad using a polishing head.

In an embodiment, there is provided a method comprising: moving a polishing head in a direction perpendicular to a polishing surface of a polishing pad while applying thrust from the polishing head to the polishing pad; during the movement of the polishing head, detecting deflection of a head arm with a strain sensor, the head arm supporting the polishing head; and determining a position of the polishing head corresponding to a point in time at which an output signal from the strain sensor reaches a preset threshold value.

In an embodiment, moving of the polishing head in the direction perpendicular to the polishing surface of the polishing pad is performed with a substrate, held by the polishing head, in contact with the polishing surface.

In an embodiment, the method further comprises determining a reference height of the polishing head relative to the polishing surface by adding a predetermined distance to the determined position.

In an embodiment, the method further comprises: calculating an amount of wear of the polishing pad; and updating the reference height of the polishing head by subtracting the amount of wear from the reference height of the polishing head.

In an embodiment, the method further comprises obtaining a relationship between thrust applied from the polishing head to the polishing pad and output signal of the strain sensor.

In an embodiment, obtaining the relationship between the thrust and the output signal of the strain sensor comprises: pressing a pressing member against a load measuring device on the polishing surface at different loads while obtaining corresponding output signals of the strain sensor, the pressing member having been attached, instead of the polishing head, to a polishing head shaft; and determining a linear function representing a relationship between the thrust and the output signal of the strain sensor based on measurement values of the different loads output from the load measuring device and the corresponding output signals.

In an embodiment, the pressing member has a spherical pressing surface.

In an embodiment, there is provided a polishing apparatus comprising: a polishing table for supporting a polishing pad; a polishing head configured to press a substrate against the polishing pad; an actuator configured to move the polishing head toward a polishing surface of the polishing pad; a head arm supporting the polishing head; a strain sensor configured to detect deflection of the head arm; and an operation controller electrically connected to the strain sensor, the operation controller including: a memory storing a program configured to determine a position of the polishing head corresponding to a point in time at which an output signal from the strain sensor reaches a preset threshold value; and a processing device configured to execute the program.

In an embodiment, the strain sensor includes a sensor head secured to an upper surface or a lower surface of the head arm, the sensor head being configured to sense the deflection of the head arm.

In an embodiment, the memory stores therein a linear function representing a relationship between thrust applied from the polishing head to the polishing pad and output signal of the strain sensor.

The amount of deflection of the head arm depends on the thrust applied from the polishing head to the polishing pad and does not depend on other factors. Therefore, as long as the thrust is the same, the magnitude of the deflection of the head arm is also the same regardless of the passage of time. The output signal of the strain sensor accurately reflects the magnitude of deflection of the head arm (i.e., the thrust) without being influenced by the passage of time. As a result, an accurate reference height of the polishing head can be determined each time a pad search is performed.

### BRIEF DESCRIPTION OF THE DRAWINGS

FIG. 1 is a side view showing an embodiment of a polishing apparatus;

FIG. 2 is a cross-sectional view showing a polishing head;

FIG. 3 is a graph showing an example of a linear function showing a relationship between thrust and output signal of a strain sensor;

FIG. 4 is a flow chart illustrating one embodiment of operations from pad search to wafer polishing;

FIG. 5 is a side view of a pressing member used when measuring thrust;

FIG. 6 is a view in which the thrust of the pressing member is measured by a load cell as a load measuring device disposed on a polishing surface of a polishing pad; and

FIG. 7 is a schematic view showing configurations of an operation controller.

### DESCRIPTION OF EMBODIMENTS

Embodiments will be described below with reference to the drawings.

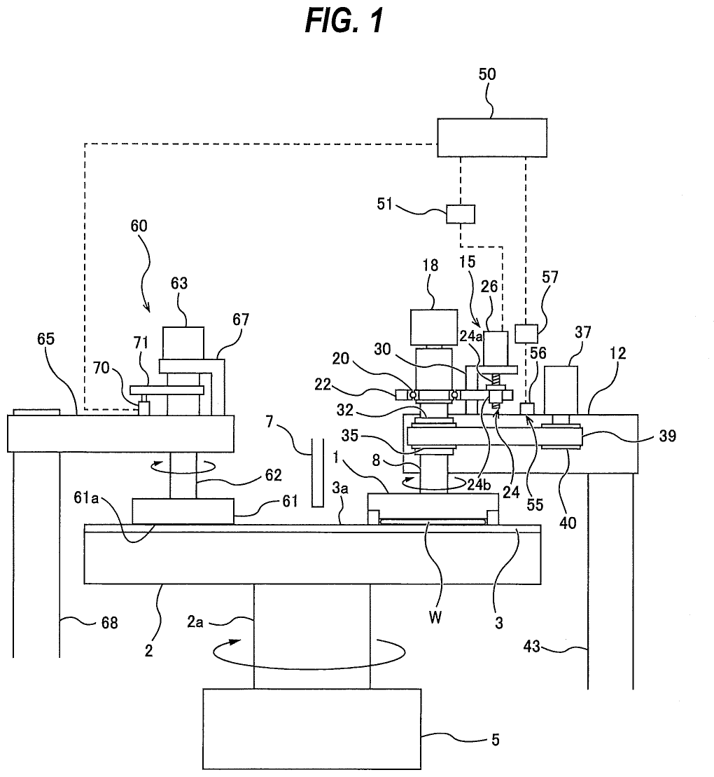

FIG. 1 is a view showing an embodiment of a polishing apparatus. As shown in FIG. 1, the polishing apparatus includes a polishing table 2 for supporting a polishing pad 3, and a polishing head (or a substrate holder) 1 for holding a wafer W, which is an example of a substrate, and pressing the wafer W against the polishing pad 3 on the polishing table 2.

The polishing table 2 is coupled through a table shaft 2a to a table motor 5 which is disposed below the polishing table 2, so that the polishing table 2 is rotatable about the table shaft 2a. The polishing pad 3 is attached to an upper surface of the polishing table 2. An upper surface of the polishing pad 3 serves as a polishing surface 3a for polishing the wafer W. A polishing-liquid supply nozzle 7 is provided above the polishing table 2 to supply a polishing liquid (e.g., a slurry) onto the polishing surface 3a of the polishing pad 3.

The polishing head 1 is removably secured to a lower end of a polishing head shaft 8, which is vertically movable relative to a head arm 12 by an actuator 15. The vertical movement of the polishing head shaft 8 enables the entirety of the polishing head 1 to move upward and downward with respect to the head arm 12 and enables positioning of the entirety of the polishing head 1. The polishing head 1 is supported by the head arm 12 through the polishing head shaft 8 and the actuator 15. The polishing head shaft 8 extends through the head arm 12.

The actuator 15 is configured to be able to move the polishing head 1 and the polishing head shaft 8 relative to the head arm 12. The direction of the polishing head 1 moved by the actuator 15 is perpendicular to the polishing surface 3a. A rotary joint 18 is mounted to an upper end of the polishing head shaft 8.

The actuator 15 for vertically moving the polishing head shaft 8 and the polishing head 1 are secured to a support pedestal 30. This support pedestal 30 is secured to an upper surface of the head arm 12. The actuator 15 includes a bearing 20 rotatably supporting the polishing head shaft 8, a bridge 22 holding the bearing 20, a ball-screw mechanism 24 coupled to the bridge 22, and a servomotor 26 secured to the support pedestal 30.

The ball-screw mechanism 24 includes a screw shaft 24a coupled to the servomotor 26 and a nut 24b that engages with the screw shaft 24a. The nut 24b is held by the bridge 22. The polishing head shaft 8 is vertically movable together with the bearing 20 and the bridge 22. When the servomotor 26 is set in motion, the bridge 22 moves vertically through the ball-screw mechanism 24, so that the polishing head shaft 8 and the polishing head 1 move vertically. The polishing head 1 is coupled to the head arm 12 via the polishing head shaft 8, the actuator 15, and the support pedestal 30.

The polishing head shaft 8 is supported by a ball spline bearing 32 so as to be movable in the axial direction of the polishing head shaft 8. A pulley 35 is fixed to an outer peripheral portion of the ball spline bearing 32. A polishing-head rotation motor 37 is fixed to the head arm 12, and the pulley 35 is coupled to a pulley 40 via a belt 39. The pulley 40 is attached to the polishing-head rotation motor 37. Therefore, when the polishing-head rotation motor 37 is set in rotating motion, the ball spline bearing 32 and the polishing head shaft 8 rotate together through the pulley 40, the belt 39, and the pulley 35, so that the polishing head 1 rotates about the polishing head shaft 8. The pulleys 35, 40, the belt 39, and the ball spline bearings 32 are arranged in the head arm 12.

The head arm 12 is supported by a pivot shaft 43, which is supported by a frame (not shown). The polishing head 1 is configured to be able to hold the wafer W on its lower surface. The head arm 12 is configured to be pivotable about the pivot shaft 43. The polishing head 1, holding the wafer W on the lower surface thereof, is moved from a position for receiving the wafer W to a position above the polishing table 2 by the swing of the head arm 12.

The polishing apparatus includes an operation controller 50 for controlling various devices including the polishing head 1, the polishing-head rotation motor 37, and the servomotor 26. The servomotor 26 is coupled to a motor driver 51, and this motor driver 51 is coupled to the operation controller 50. The operation controller 50 sends an instruction signal to the motor driver 51, and the motor driver 51 in turn drives the servomotor 26 according to the instruction signal.

Polishing of the wafer W is performed as follows. While the polishing head 1 and the polishing table 2 are rotated individually, the polishing liquid is supplied onto the polishing surface 3a of the polishing pad 3 from the polishing-liquid supply nozzle 7. In this state, the polishing head 1 is lowered to a predetermined reference height, at which the polishing head 1 presses the wafer W against the polishing surface 3a of the polishing pad 3. The wafer W is placed in sliding contact with the polishing surface 3a of the polishing pad 3 in the presence of the polishing liquid, so that a surface of the wafer W is polished.

The polishing apparatus includes a strain sensor 55 configured to detect deflection of the head arm 12. The strain sensor 55 is configured to generate an output signal that varies according to a magnitude of the deflection of the head arm 12. The strain sensor 55 includes a sensor head 56 fixed to the head arm 12 and a sensor amplifier 57 electrically connected to the sensor head 56. The sensor head 56 has an element, such as a piezoelectric element or a metal resistor, capable of sensing the deflection of the head arm 12, and outputs an electrical signal that varies according to the magnitude of the deflection of the head arm 12. This electrical signal is sent to the sensor amplifier 57 and amplified by the sensor amplifier 57.

The sensor head 56 is fixed to the upper surface of the head arm 12. In one embodiment, the sensor head 56 may be fixed to a lower surface of the head arm 12. In order to accurately sense the deflection of the head arm 12, the sensor head 56 is located between a lower end of the support pedestal 30 which is the point of application of a force applied to the head arm 12 and the pivot shaft 43 which is the fulcrum of the head arm 12. In the present embodiment, the sensor head 56 is located on the upper surface of the head arm 12 at approximately the midpoint between the point of application and the fulcrum.

The output signal of the strain sensor 55 varies in accordance with the magnitude of the deflection of the head arm 12. This output signal may comprise a numerical value, such as a current value or a voltage value, which indirectly represents the magnitude of the deflection, or may comprise a numerical value which directly represents the magnitude of the deflection. The configuration of the strain sensor 55 is not limited to the present embodiment. A strain sensor having different configurations may be used as long as it can generate an output signal that varies in accordance with the magnitude of deflection of the head arm 12. The strain sensor 55 may further include a converter that converts the signal output from the sensor amplifier 57 into another form of signal.

The strain sensor 55 is electrically connected to the operation controller 50. More specifically, the sensor amplifier 57 is electrically connected to the operation controller 50. The output signal of the strain sensor 55 is transmitted to the operation controller 50. The strain sensor 55 is used in a process of determining the above-mentioned reference height of the polishing head 1 as described later.

The polishing apparatus includes a dressing unit 60 for dressing the polishing surface 3a of the polishing pad 3. The dressing unit 60 includes a dresser 61 which is brought into sliding contact with the polishing surface 3a of the polishing pad 3, a dresser shaft 62 coupled to the dresser 61, a pneumatic cylinder 63 provided at an upper end of the dresser shaft 62, and a dresser arm 65 rotatably supporting the dresser shaft 62. The lower surface of the dresser 61 constitutes a dressing surface 61a, which is constituted by abrasive grains (e.g., diamond particles). The pneumatic cylinder 63 is secured to the support base 67, and this support base 67 is secured to the dresser arm 65.

When a motor (not shown) coupled to the support shaft 68 is in motion, the dresser arm 65 pivots about the support shaft 68. The dresser shaft 62 is rotated by a dresser rotation motor (not shown) disposed in the dresser arm 65. This rotation of the dresser shaft 62 causes the dresser 61 to rotate about the dresser shaft 62 in a direction indicated by arrow. The pneumatic cylinder 63 is coupled to the dresser 61 via the dresser shaft 62. The pneumatic cylinder 63 moves the dresser shaft 62 and the dresser 61 together vertically to press the dressing surface 61a of the dresser 61 against the polishing surface 3a of the polishing pad 3 at a predetermined force.

Dressing of the polishing surface 3a of the polishing pad 3 is performed as follows. While the polishing pad 3 is rotated together with the polishing table 2 by the table motor 5, pure water is supplied from a pure-water supply nozzle (not shown) onto the polishing surface 3a. The dressing surface 61a of the dresser 61 is pressed against the polishing surface 3a by the pneumatic cylinder 63, while the dresser 61 rotates around the dresser shaft 62. The dresser 61 is placed in sliding contact with the polishing surface 3a in the presence of the pure water on the polishing surface 3a. While the dresser 61 is rotating, the dresser arm 65 pivots around the pivot shaft 68 to cause the dresser 61 to move in a radial direction of the polishing surface 3a. In this manner, the dresser 61 scrapes the polishing pad 3 to thereby dress (or restore) the polishing surface 3a.

The dressing unit 60 includes a displacement sensor 70 for measuring a height of the dresser 61 (i.e., a vertical position of the dresser 61 relative to the polishing surface 3a). The displacement sensor 70 is secured to the dresser arm 65. A target plate 71 is secured to the dresser shaft 62. This target plate 71 moves up and down together with the vertical movement of the dresser 61 and the dresser shaft 62. The displacement sensor 70 is directed at the target plate 71, and is configured to measure the height of the target plate 71 (i.e., the position of the target plate 71 in the vertical direction).

When the pneumatic cylinder 63 operates, the dresser 61, the dresser shaft 62, and the target plate 71 are moved together in the vertical direction. In contrast, the dresser arm 65 is fixed in its vertical position. The displacement sensor 70 measures the vertical position of the target plate 71 with respect to the dresser arm 65 to thereby indirectly measure the height of the dresser 61. In the present embodiment, a contact-type displacement sensor that contacts the target plate 71 is used as the displacement sensor 70, while a non-contact type displacement sensor that does not contact the target plate 71 may be used. Specifically, a linear scale, a laser sensor, an ultrasonic sensor, or an eddy current sensor can be used as the displacement sensor 70.

The displacement sensor 70 is electrically connected to the operation controller 50, and a measurement value of the vertical position of the dresser 61 is sent to the operation controller 50. The polishing pad 3 gradually wears along with polishing of wafers and dressing of the polishing pad 3. The operation controller 50 is configured to calculate an amount of wear of the polishing pad 3 based on measurement values sent from the displacement sensor 70. More specifically, the operation controller 50 calculates a difference between an initial measurement value and a current measurement value of the vertical position of the dresser 61 in contact with the polishing surface 3a. This difference corresponds to the amount of wear of the polishing pad 3.

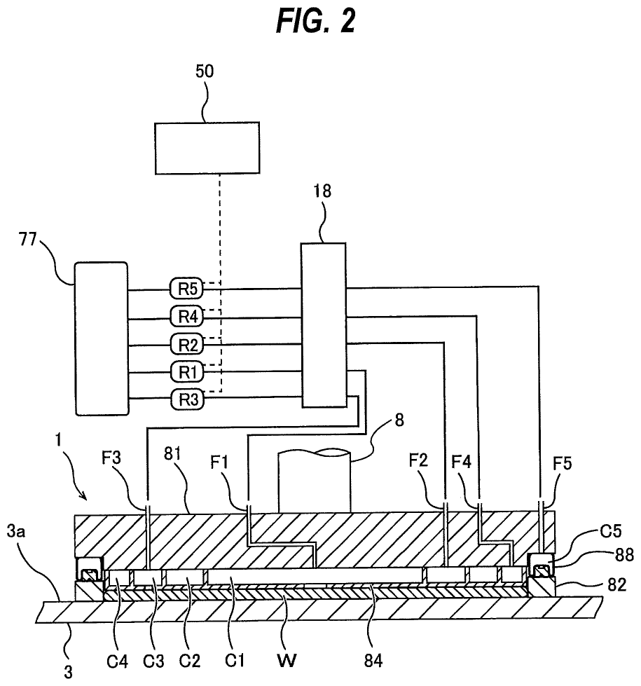

Next, the polishing head 1 will be described in detail with reference to FIG. 2. FIG. 2 is a cross-sectional view showing the polishing head 1. The polishing head 1 includes a head body 81 fixed to the polishing head shaft 8, and a retainer ring 82 disposed below the head body 81. A flexible membrane (or an elastic membrane) 84, which is brought into contact with the wafer W, is secured to a lower portion of the head body 81. Four pressure chambers C1, C2, C3, and C4 are provided between the membrane 84 and the head body 81. The pressure chambers C1, C2, C3, and C4 are formed by the membrane 84 and the head body 81. The central pressure chamber C1 has a circular shape, and the other pressure chambers C2, C3, and C4 have an annular shape. These pressure chambers C1, C2, C3, and C4 are in a concentric arrangement. In one embodiment, more than four pressure chambers or less than four pressure chambers may be provided.

A compressed gas, such as compressed air, is supplied into the pressure chambers C1, C2, C3, and C4 from a gas supply source 77 through fluid passages F1, F2, F3, and F4, respectively. The wafer W is pressed against the polishing surface 3a of the polishing pad 3 by the membrane 84. More specifically, the pressure of the compressed gas in the pressure chambers C1, C2, C3, and C4 acts on the wafer W through the membrane 84 to press the wafer W against the polishing surface 3a. The pressures in the pressure chambers C1 to C4 can be changed independently to thereby independently adjust polishing pressures on corresponding four areas of the wafer W, i.e., a central area; an inner intermediate area; an outer intermediate area; and an edge area. The pressure chambers C1, C2, C3, and C4 communicate with a vacuum source (not shown) via the fluid passages F1, F2, F3, and F4.

A periphery of the wafer W is surrounded by the retainer ring 82, so that the wafer W does not come out of the polishing head 1 during polishing of the wafer W. The membrane 84 has an opening formed in a portion that forms the pressure chamber C3, so that the wafer W can be held by the polishing head 1 via vacuum suction by producing a vacuum in the pressure chamber C3. Further, the wafer W can be released from the polishing head 1 by supplying a nitrogen gas or clean air into the pressure chamber C3.

An annular rolling diaphragm 88 is provided between the head body 81 and the retainer ring 82, and a pressure chamber C5 is formed in this rolling diaphragm 88. The pressure chamber C5 communicates with the above-described gas supply source 77 through a fluid passage F5. The gas supply source 77 supplies the compressed gas into the pressure chamber C5, so that the compressed gas in the pressure chamber C5 presses the retainer ring 82 against the polishing pad 3.

The fluid passages F1, F2, F3, F4, and F5 extend from the pressure chambers C1, C2, C3, C4, and C5 to the gas supply source 77 via the rotary joint 18. The fluid passages F1, F2, F3, F4, and F5 are provided with pressure regulators R1, R2, R3, R4, and R5, respectively. The compressed gas from the gas supply source 77 is supplied through the pressure regulators R1 to R5, the rotary joint 18, and the fluid passages F1 to F5 into the pressure chambers C1 to C5, respectively. The pressure regulators R1 to R5 are configured to regulate the pressures in the pressure chambers C1 to C5. The pressure regulators R1, R2, R3, R4, and R5 are coupled to the operation controller 50. The fluid passages F1, F2, F3, F4 and F5 are coupled to vent valves (not shown), respectively, so that the pressure chambers C1, C2, C3, C4, and C5 can be vented to the atmosphere.

The operation controller 50 is configured to generate target pressure values for the pressure chambers C1 to C5, respectively. The target pressure values for the pressure chambers C1 to C5 are determined based on film-thickness measurement values of the wafer. The operation controller 50 sends the target pressure values to the pressure regulators R1 to R5, respectively, and the pressure regulators R1 to R5 operate so that the pressures in the pressure chambers C1 to C5 coincide with the corresponding target pressure values. The polishing head 1 having the multiple pressure chambers C1, C2, C3, and C4 can press the respective regions of the surface of the wafer W independently against the polishing pad 3 as the polishing progresses, so that the film of the wafer W can be polished uniformly.

During polishing of the wafer W, the polishing head 1 is maintained at the reference height. Specifically, the compressed gas is supplied into the pressure chambers C1, C2, C3, C4, and C5 while the polishing head 1 is located at the reference height. The membrane 84 forming the pressure chambers C1, C2, C3, and C4 presses the wafer W against the polishing surface 3a of the polishing pad 3, and the rolling diaphragm 88 forming the pressure chamber C5 presses the retainer ring 82 against the polishing surface 3a of the polishing pad 3.

The reference height of the polishing head 1 is the height of the entirety of the polishing head 1 relative to the polishing surface 3a of the polishing pad 3. The reference height of the polishing head 1 affects a polishing load applied to a wafer. Therefore, when wafers are polished, the reference height of the polishing head 1 needs to be always the same. However, the polishing pad 3 gradually wears along with polishing of wafers and dressing of the polishing pad 3. As a result, the reference height of the polishing head 1 changes. Thus, in order to keep the reference height of the polishing head 1 constant regardless of the wear of the polishing pad 3, the reference height of the polishing head 1 is adjusted in accordance with the amount of wear of the polishing pad 3.

The reference height of the polishing head 1 is determined before the polishing pad 3 wears (i.e., before the polishing pad 3 is used for wafer polishing). In order to determine the reference height of the polishing head 1, it is first necessary to detect the polishing surface 3a of the polishing pad 3. In the present specification, an operation of detecting the polishing surface 3a of the polishing pad 3 is referred to as pad search.

The pad search is performed using the polishing head 1. Specifically, the pad search is performed while the polishing head 1 applies a thrust to the polishing pad 3. The thrust of the polishing head 1 is generated by the above-described actuator 15 (more specifically, the servomotor 26). The polishing head 1 receives a reaction force from the polishing pad 3. This reaction force is transmitted to the head arm 12 via the polishing head shaft 8, the actuator 15, and the support pedestal 30. As a result, the head arm 12 bends upward. The strain sensor 55 described above generates an output signal corresponding to the deflection of the head arm 12, and sends this output signal to the operation controller 50. The operation controller 50 stores in advance a linear function representing a relationship between the thrust and the output signal of the strain sensor 55. Therefore, the operation controller 50 can determine the thrust applied from the polishing head 1 to the polishing pad 3 based on the output signal of the strain sensor 55.

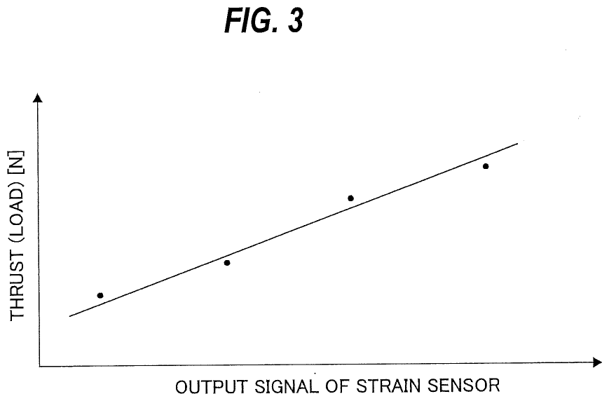

FIG. 3 is a graph showing an example of the linear function showing the relationship between the thrust and the output signal of the strain sensor 55. A vertical axis in FIG. 3 represents the thrust (load) applied from the polishing head 1 to the polishing pad 3, and a horizontal axis represents the output signal of the strain sensor 55. The output signal comprises a numerical value that directly or indirectly indicates the magnitude of the deflection of the head arm 12. As shown in FIG. 3, the thrust is proportional to the output signal of the strain sensor 55. Therefore, the operation controller 50 can determine the thrust from the output signal of the strain sensor 55 and the linear function.

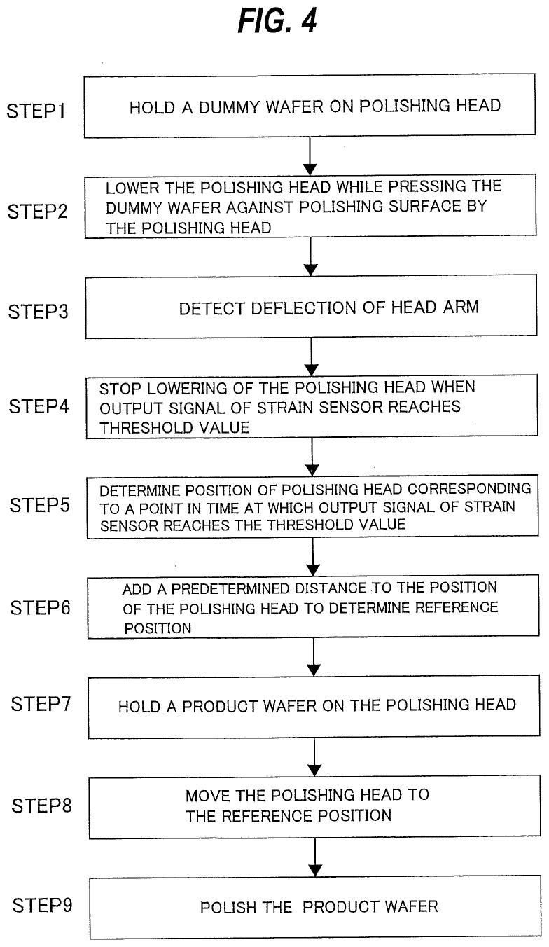

FIG. 4 is a flow chart describing one embodiment of operations from the pad search to wafer polishing. In step 1, the polishing head 1 holds a dummy wafer (or a dummy substrate) on the membrane 84. The dummy wafer (dummy substrate) is a wafer (substrate) having a predetermined thickness. Instead of the dummy wafer (dummy substrate), a product wafer (or a product substrate) having a predetermined thickness may be used.

In step 2, the polishing head 1 is lowered (moved) while pressing the dummy wafer against the polishing surface 3a. More specifically, the operation controller 50 sends an instruction signal to the motor driver 51 to operate the actuator 15. The actuator 15 lowers the polishing head 1 toward the polishing surface 3a of the polishing pad 3 at a predetermined speed, and presses the dummy wafer against the polishing surface 3a with the polishing head 1. At this time, the polishing head 1 and the polishing table 2 are not rotating. While the polishing head 1 presses the dummy wafer against the polishing surface 3a, the polishing head 1 continues to be lowered at the predetermined speed. The moving direction of the polishing head 1 at this time is perpendicular to the polishing surface 3a. While the polishing head 1 presses the dummy wafer against the polishing surface 3a, the pressure chambers C1-C5 of the polishing head 1 are open to the atmosphere. The thrust of the polishing head 1 is applied to the polishing surface 3a of the polishing pad 3 through the dummy wafer. The retainer ring 82 simply contacts the polishing surface 3a by its own weight.

In step 3, the strain sensor 55 detects the deflection of the head arm 12 while the polishing head 1 is moving. The above steps 2, 3 are actually performed simultaneously. As the polishing head 1 is lowered, the thrust applied from the polishing head 1 to the polishing surface 3a of the polishing pad 3 increases. In other words, the reaction force applied from the polishing pad 3 to the polishing head 1 increases as the polishing head 1 is lowered. This reaction force causes the head arm 12 to bend upward. The strain sensor 55 sends the output signal reflecting the magnitude of deflection of the head arm 12 to the operation controller 50.

In step 4, when the output signal from the strain sensor 55 reaches a preset threshold value, the operation controller 50 sends an instruction signal to the motor driver 51 to stop the movement (lowering) of the polishing head 1.

In step 5, the operation controller 50 determines the position of the polishing head 1 corresponding to a point in time at which the output signal from the strain sensor 55 reaches the preset threshold value. The position of the polishing head 1 is the height of the entire polishing head 1 relative to the polishing surface 3a of the polishing pad 3. The position of the polishing head 1 can be obtained from the number of rotations of the servomotor 26 and the thread pitch of the ball-screw mechanism 24.

In step 6, the operation controller 50 adds a predetermined distance to the determined position of the polishing head 1 to determine the reference height of the polishing head 1 with respect to the polishing surface 3a. The predetermined distance is a distance in a direction away from the polishing surface 3a.

In step 7, the polishing head 1 holds a product wafer instead of the dummy wafer.

In step 8, the operation controller 50 sends an instruction signal to the motor driver 51 to operate the actuator 15 to move the polishing head 1 to the determined reference height.

In step 9, while the polishing-liquid supply nozzle 7 supplies the polishing liquid to the polishing surface 3a of the polishing pad 3 on the rotating polishing table 2, the polishing head 1 at the reference height presses the product wafer against the polishing surface 3a to thereby polish the product wafer.

The magnitude of the deflection of the head arm 12 depends on the thrust applied from the polishing head 1 to the polishing pad 3, and does not depend on other factors. Therefore, as long as the thrust is the same, the magnitude of the deflection of the head arm 12 is also the same regardless of the passage of time. The output signal of the strain sensor 55 accurately reflects the magnitude of deflection of the head arm 12 (i.e., the thrust) without being influenced by the passage of time. As a result, the operation controller 50 can determine the accurate reference height of the polishing head 1 each time the pad search is performed.

The pad search and the determination of the reference height of the polishing head 1 are performed each time the polishing pad 3 is replaced with a new one. More specifically, after a new polishing pad 3 is attached to the polishing table 2, a polishing surface 3a of the new polishing pad 3 is dressed by the dresser 61. Thereafter, the pad search and the determination of the reference height of the polishing head 1 are performed.

As described above, the polishing pad 3 gradually wears with polishing of wafers and dressing of the polishing pad 3. As a result, the reference height of the polishing head 1 changes. Thus, the reference height of the polishing head 1 is adjusted according to the amount of wear of the polishing head 1 so that the reference height of the polishing head 1 is kept constant regardless of the wear of the polishing pad 3. Specifically, every time one wafer or a predetermined number of wafers are polished, the operation controller 50 calculates the amount of wear of the polishing pad 3, and subtracts the amount of wear from the reference height of the polishing head 1, thereby updating the reference height of the polishing head 1. With such operations, the reference height of the polishing head 1 can always be kept constant without being affected by the wear of the polishing pad 3.

The linear function shown in FIG. 3 can be obtained by actually measuring different thrusts, obtaining output signals of the strain sensor 55 corresponding to the different thrusts, plotting coordinate points, specified by measurement values of the thrusts and the corresponding output signals, on a coordinate system, and performing regression analysis on these coordinate points. The linear function representing the relationship between the thrust and the output signal of the strain sensor 55 is obtained before the pad search. Once the relationship between the thrust and the output signal of the strain sensor 55 is obtained, the relationship (represented by the linear function) can be used in a plurality of pad searches performed thereafter.

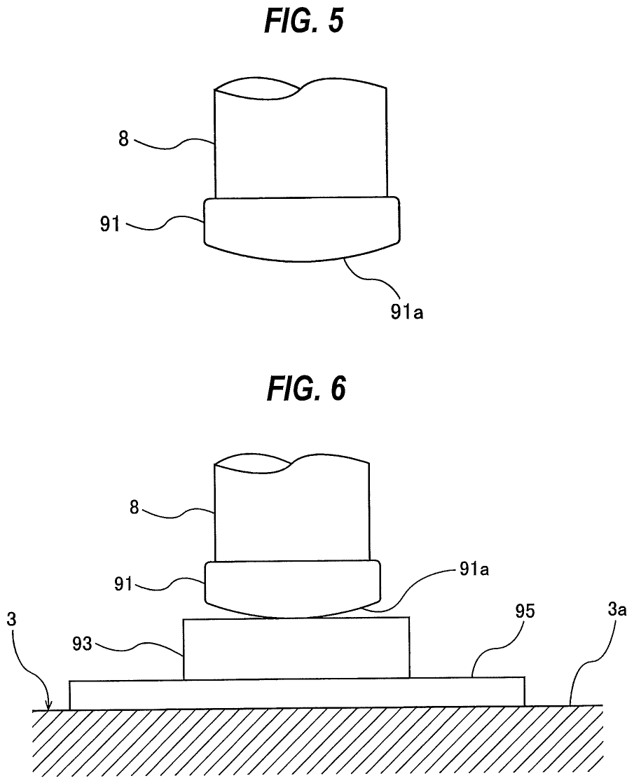

When the thrust is to be measured, the polishing head 1 is removed from the polishing head shaft 8, and a pressing member 91 shown in FIG. 5 is secured to the polishing head shaft 8. The pressing member 91 is fixed to the lower end of the polishing head shaft 8 by a screw or screws (not shown). As shown in FIG. 5, the pressing member 91 has a spherical pressing surface 91a. This pressing surface 91a constitutes a lower surface of the pressing member 91. The lowermost point of the spherical pressing surface 91a coincides with the center of the pressing member 91, and coincides with the central axis of the polishing head shaft 8.

FIG. 6 is a view showing the manner in which the thrust of the pressing member 91 is measured by a load cell 95 as a load measuring device disposed on the polishing surface 3a of the polishing pad 3. A spacer 93 is disposed between the load cell 95 and the pressing member 91. The spacer 93 may be omitted. When the actuator 15 (see FIG. 1) is set in motion, the pressing surface 91a of the pressing member 91 presses the load cell 95 through the spacer 93. The pressing surface 91a of the pressing member 91 is placed in point contact with the spacer 93. The thrust of the pressing member 91 in this state corresponds to the thrust of the polishing head 1. The load cell 95 measures the thrust (load) of the pressing member 91.

As can be seen from FIG. 6, since the pressing surface 91a is spherical, only the center of the pressing member 91 contacts the spacer 93. If the pressing surface 91a is flat, the point of action of the thrust deviates from the central axis of the polishing head shaft 8 unless the polishing head shaft 8 is completely perpendicular to the polishing surface 3a. As a result, the load cell 95 cannot measure an accurate thrust. According to the present embodiment, since the point of action of the thrust is on the central axis of the polishing head shaft 8, the load cell 95 can measure an accurate thrust.

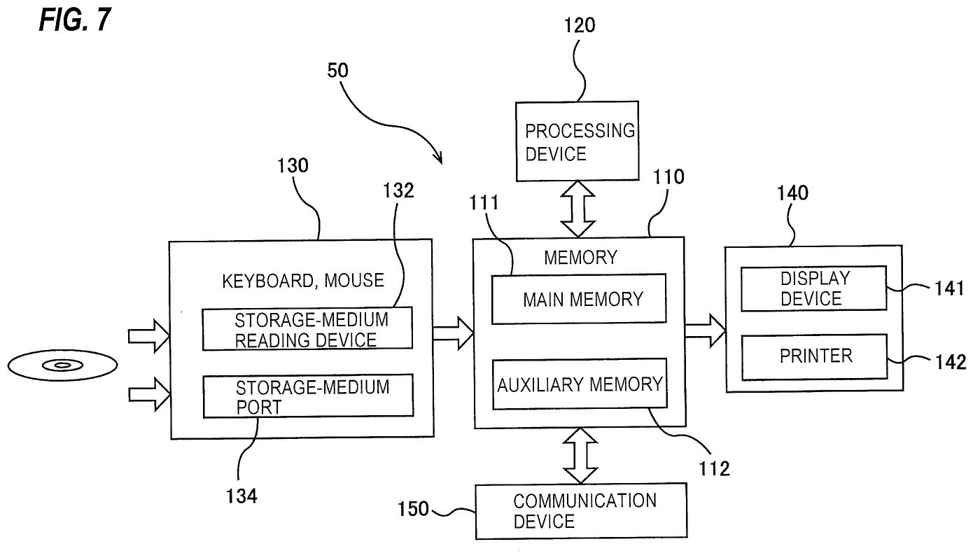

In the present embodiment, the operation controller 50 is constituted by a dedicated computer or a general-purpose computer. FIG. 7 is a schematic diagram showing configurations of the operation controller 50. As shown in FIG. 11, the operation controller 50 includes a memory 110 in which a program and data are stored, a processing device 120, such as CPU (central processing unit), for performing arithmetic operation according to the program stored in the memory 110, an input device 130 for inputting the data, the program, and various information into the memory 110, an output device 140 for outputting processing results and processed data, and a communication device 150 for connecting to a network, such as the Internet.

The memory 110 includes a main memory 111 which is accessible by the processing device 120, and an auxiliary memory 112 that stores the data and the program therein. The main memory 111 may be a random-access memory (RAM), and the auxiliary memory 112 is a storage device which may be a hard disk drive (HDD) or a solid-state drive (SSD).

The input device 130 includes a keyboard and a mouse, and further includes a storage-medium reading device 132 for reading the data from a storage medium, and a storage-medium port 134 to which a storage medium can be connected. The storage medium is a non-transitory tangible computer-readable storage medium. Examples of the storage medium include optical disk (e.g., CD-ROM, DVD-ROM) and semiconductor memory (e.g., USB flash drive, memory card). Examples of the storage-medium reading device 132 include optical drive (e.g., CD drive, DVD drive) and card reader. Examples of the storage-medium port 134 include USB terminal. The program and/or the data stored in the storage medium is introduced into the operation controller 50 via the input device 130, and is stored in the auxiliary memory 112 of the memory 110. The output device 140 includes a display device 141 and a printer 142.

The memory 110 stores the program therein for determining the position of the polishing head 1 corresponding to a point in time at which the output signal from the strain sensor 55 reaches the preset threshold value, and determining the reference height from the determined position of the polishing head 1. This program is executed by the processing device 120. Furthermore, the memory 110 stores therein the linear function indicating the relationship between the thrust applied from the polishing head 1 to the polishing pad 3 and the output signal of the strain sensor 55.

The program is stored in a non-transitory tangible computer-readable storage medium, and is then provided to the operation controller 50 via the storage medium. The program may be provided to the operation controller 50 via communication network, such as the Internet.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A method comprising:
moving a polishing head in a direction perpendicular to a polishing surface of a polishing pad while applying thrust from the polishing head to the polishing pad;
during the movement of the polishing head, detecting deflection of a head arm with a strain sensor, the head arm supporting the polishing head; and
determining a position of the polishing head corresponding to a point in time at which an output signal from the strain sensor reaches a preset threshold value.

2. The method according to claim 1, wherein moving of the polishing head in the direction perpendicular to the polishing surface of the polishing pad is performed with a substrate, held by the polishing head, in contact with the polishing surface.

3. The method according to claim 1, further comprising:
determining a reference height of the polishing head relative to the polishing surface by adding a predetermined distance to the determined position.

4. The method according to claim 3, further comprising:
calculating an amount of wear of the polishing pad; and
updating the reference height of the polishing head by subtracting the amount of wear from the reference height of the polishing head.

5. The method according to claim 1, further comprising:
obtaining a relationship between thrust applied from the polishing head to the polishing pad and output signal of the strain sensor.

6. The method according to claim 5, wherein obtaining the relationship between the thrust and the output signal of the strain sensor comprises:
pressing a pressing member against a load measuring device on the polishing surface at different loads while obtaining corresponding output signals of the strain sensor, the pressing member having been attached, instead of the polishing head, to a polishing head shaft; and
determining a linear function representing a relationship between the thrust and the output signal of the strain sensor based on measurement values of the different loads output from the load measuring device and the corresponding output signals.

7. The method according to claim 6, wherein the pressing member has a spherical pressing surface.

8. A polishing apparatus comprising:
a polishing table for supporting a polishing pad;
a polishing head configured to press a substrate against the polishing pad;
an actuator configured to move the polishing head toward a polishing surface of the polishing pad;
a head arm supporting the polishing head;
a strain sensor configured to detect deflection of the head arm; and
an operation controller electrically connected to the strain sensor, the operation controller including:
a memory storing a program configured to determine a position of the polishing head corresponding to a point in time at which an output signal from the strain sensor reaches a preset threshold value; and
a processing device configured to execute the program.

9. The polishing apparatus according to claim 8, wherein the strain sensor includes a sensor head secured to an upper surface or a lower surface of the head arm, the sensor head being configured to sense the deflection of the head arm.

10. The polishing apparatus according to claim 8, wherein the memory stores therein a linear function representing a relationship between thrust applied from the polishing head to the polishing pad and output signal of the strain sensor.
